(19) United States
(12) Patent Application Publication
(10) Pub. No.: US 2012/0229394 A1
(43) Pub. Date: Sep. 13, 2012

(54) DISPLAY TERMINAL

(75) Inventors: Makus Ehrl, Marktoberdorf (DE); Adrian Hackfort, Eching am Ammersee (DE); Rainer Hofman, Jengen (DE); Matthias Schreiber, Unterthingau (DE); Thomas Zurl, Marktoberdorf (DE)

(73) Assignee: AGCO GMBH, Marktoberdorf (DE)

(21) Appl. No.: 13/395,995

(22) PCT Filed: Sep. 16, 2010
(86) PCT No.: PCT/EP2010/063603

§ 371 Date: May 29, 2012

(30) Foreign Application Priority Data
Sep. 16, 2009 (GB) 0916235.5

(51) Int. Cl. G06F 3/041

(52) U.S. Cl. 345/173

(57) ABSTRACT

A display terminal for a tractor or other agricultural machine. The terminal has a touch sensitive screen in which the pressing of pre-determined areas of the screen designated as control areas initiates pre-determined actions in the operation of the terminal or machine. The terminal also has a control unit and a matrix of push buttons external to the screen the pressing of which duplicates the pressing of the touch sensitive screen areas.

This invention relates to a display terminal for use in agricultural machines, such as agricultural tractors to monitor, input and control various performance parameters associated with the machine.

Agricultural machines, such as tractors have many different uses and are used to perform many tasks. In order to use the machine most efficiently (in terms of both time and cost), or to perform a task most efficiently, it is necessary to monitor and control various parameters associated with the machine and the task in hand and for information relating to these parameters to be available to the operator whilst operating the machine.

It is known to use display terminals in agricultural machinery which are capable of displaying various parameters associated with the machine and task in hand such as tyre pressure, fuel consumption, volume of crop cut etc.

Since the machine operator is pre-occupied with driving and controlling the machine, the display terminal must be simple and easy to view and use and for this reason it is helpful and advantageous for more than one parameter associated with the machine to be viewed on the screen simultaneously. Operation of display terminals can be difficult when the machine is travelling over rough ground since the vibrations and/or movement make it difficult for the operator to focus on the terminal, and for the operator to have a steady hand to operate the terminal. Further, given the environment in which the machine is used, the operator's hands may be dirty which can affect the visibility of the screen and the ability to use the terminal.

An object of the invention is to provide an improved display terminal which is suitable for use in an agricultural machine.

According to the invention there is provided a display terminal for a tractor, or other agricultural machine, the terminal having a touch sensitive screen where the pressing of pre-determined areas of the screen designated as control areas initiates predetermined actions in the operation of the terminal or machine, the terminal also having a control unit with a matrix of push buttons external to the screen the pressing of which duplicates the pressing of the touch sensitive screen areas.

The advantage of the terminal having both push buttons and a touch sensitive screen provides the machine operator with the flexibility of using the push buttons when he/she has dirty hands, the use of which may smudge, or obscure the screen. Also, whilst travelling over rough, or uneven ground, it can be difficult to steady the hand to touch the required part of the screen and push buttons are therefore preferable.

Preferably, partial areas of the display touch sensitive screen can be re-sized by touching the screen. More preferably, the re-sizing of a data mask on the terminal screen is implemented by an internal terminal scaling mechanism. This allows a very fast change of the screen size within the terminal, especially when dealing with information and data which is communicated from an implement attached to the tractor.

The control unit preferably comprises a rotary knob for the entry of data values associated with designated fields selected by using the touch sensitive screen, or the push buttons. The rotary knob may be used to scroll through items/values from a list associated with a designated field. A particular value/item may be selected by pressing the rotary knob in an axial direction, or a push button.

Preferably, the control unit comprises a steadying portion which provides a grip for steadying the operator's hand whilst allowing operation of the push buttons by the thumb of the hand. More preferably the control unit is detachable from the screen.

The display/control parameters are grouped within independent applications and the operator uses the touch screen, or push buttons to navigate around the application groups to select those which he/she wishes to display on the terminal. This way several independent applications may be displayed and controlled on the machine on only one terminal.

The screen is preferably split into a number of pre-determined areas for the display/control of different machine operating or control parameters. Preferably, the screen is divisible into four quadrants which control/monitor a particular parameter/function of the machine. Each quadrant is preferably provided with touch sensitive areas which relate to the parameter/function of that quadrant.

More preferably, the screen has an area which includes a list of pre-determined functions of the machine which can be assigned to separate areas of the screen for the display of pre-determined parameters relating to the selected function. Preferably still, the touch sensitive areas, or push buttons are used to select items from the predetermined functions in the separate areas of the screen.

Preferably, at least one area of the touch sensitive screen comprises a virtual toggle switch which indicates the state of operation of the function concerned.

Data concerning an operating or control parameter is preferably transferred between the display terminal and a personal computer via a remote server. Preferably the data is downloadable form the server over the internet. More preferably, an ISO XML format is used to transfer the data. More preferably still, the data can be saved onto a portable memory device.

The display terminal may be offered in two versions, a first higher specification version and a second lower specification version, the higher specification version having a screen which can be divided into four quadrants and the second lower specification version having a smaller undivided screen. The terminal screen is preferably rectangular in shape having a display area of approximately 15.9×21 cm. The terminal may also be offered in a less sophisticated form which has a display area of approximately half the above size

According to a further aspect of the invention there is provided a display terminal for a tractor, or other agricultural machine, the terminal having a screen and a control unit, wherein the control unit comprises a steadying portion and at least one push button, the steadying portion providing a grip for steadying the operator's hand whilst allowing operation of the at least one button by the thumb of the hand.

Preferably, the steadying portion is a handle. More preferably the handle is of an elongated form.

The at least one push button is preferably located on a pad of push buttons.

The control unit may further comprise a rotary dial operable by the thumb for the input of data of the selection of a screen displayed parameter.

Preferably the rotary dial is located adjacent to the pad of push buttons for the entry of data or the selection of items from lists.

Preferably the control unit is detachable from the terminal or terminal screen. The detachable control unit may be connected to the screen by a cable or wirelessly.

The control unit is preferably attachable to the terminal or terminal screen by the handle portion

The control unit when detached can be mounted to a support surface, such as an arm rest of a tractor cab seat.

Alternatively, the control unit may be a non detachable integral part of the terminal.

The invention will now be described, by way of example only with reference to the following drawings in which:

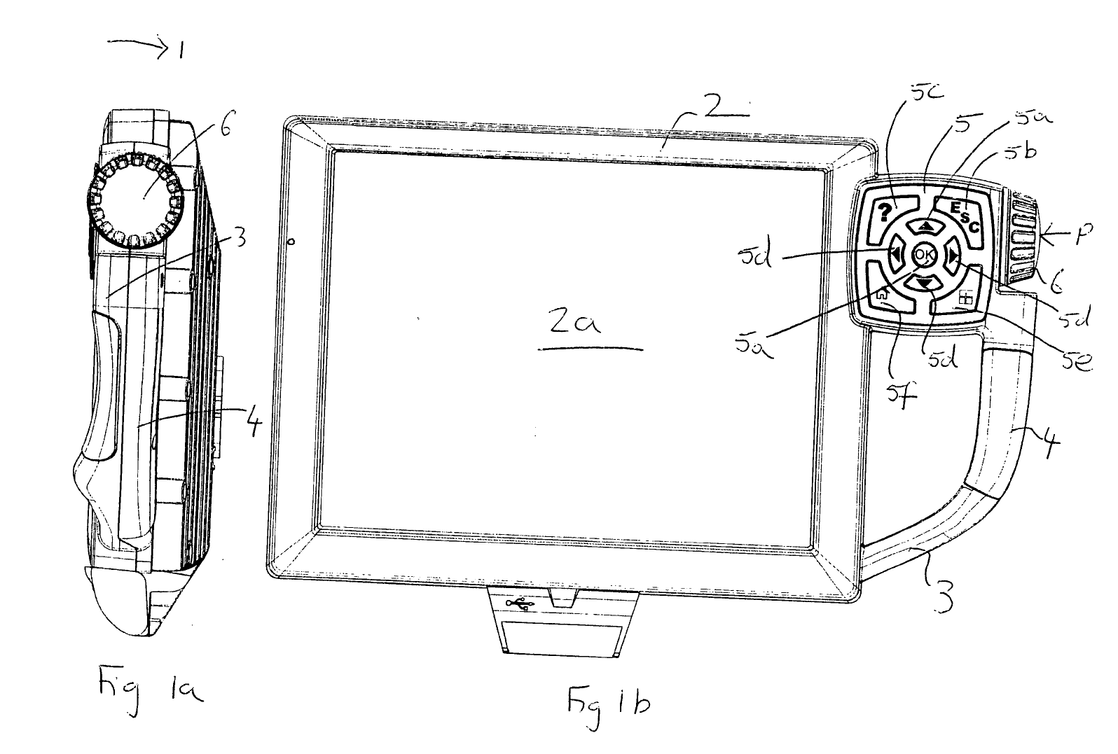

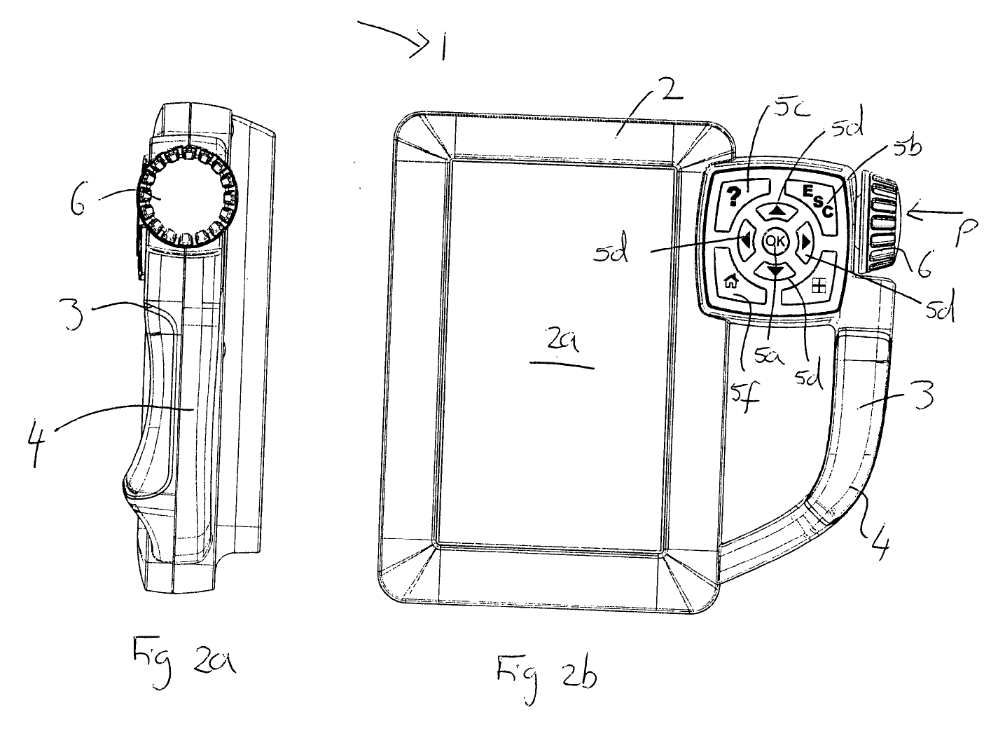

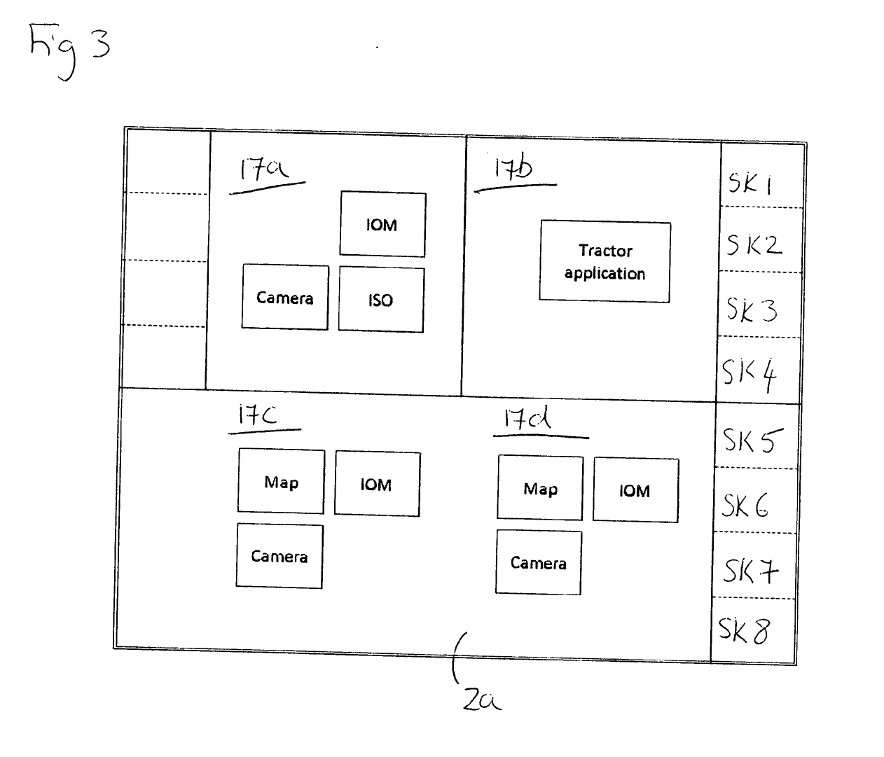

FIGS. 1a and 1b show end and forward facing views respectively of the terminal in accordance with one embodiment of the invention,

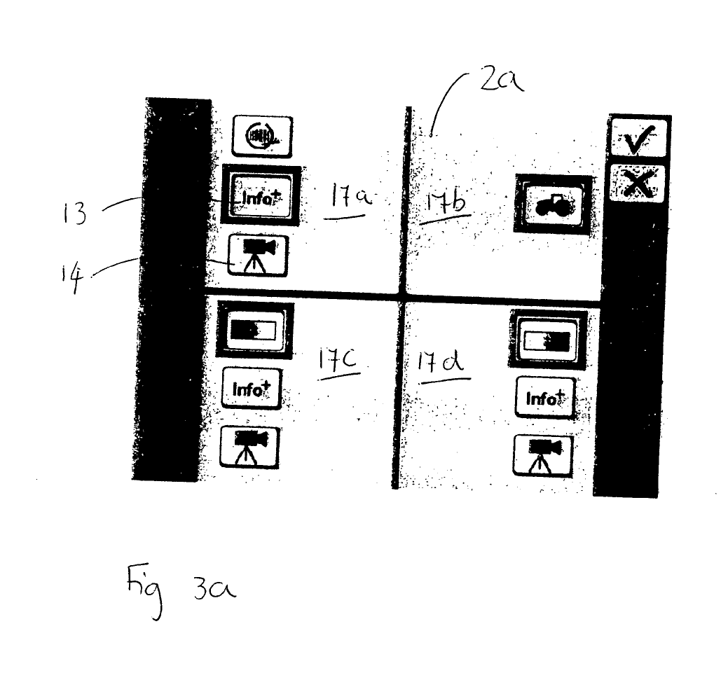

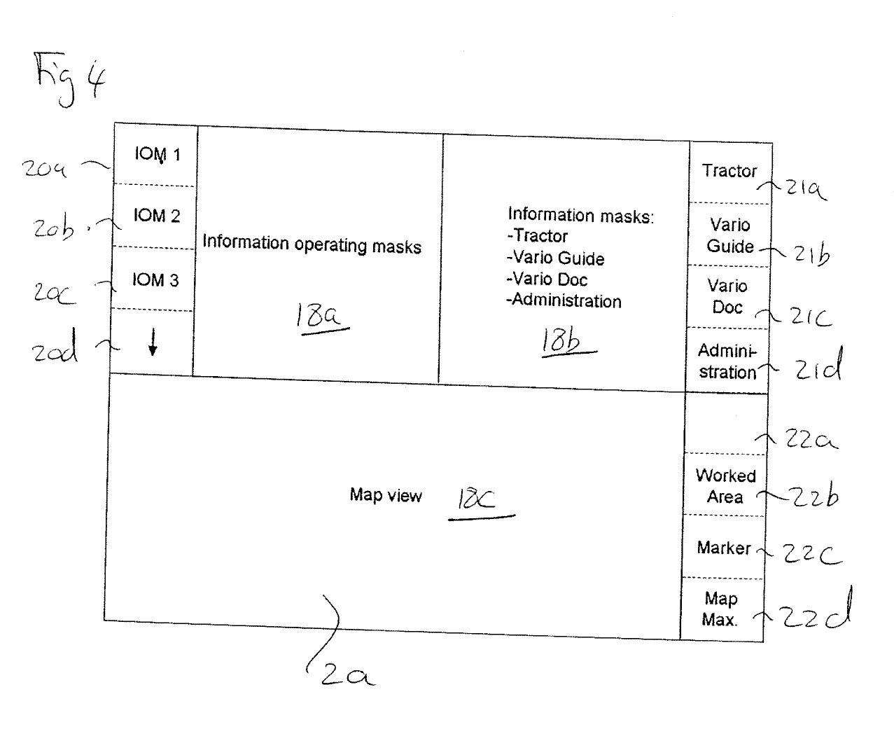

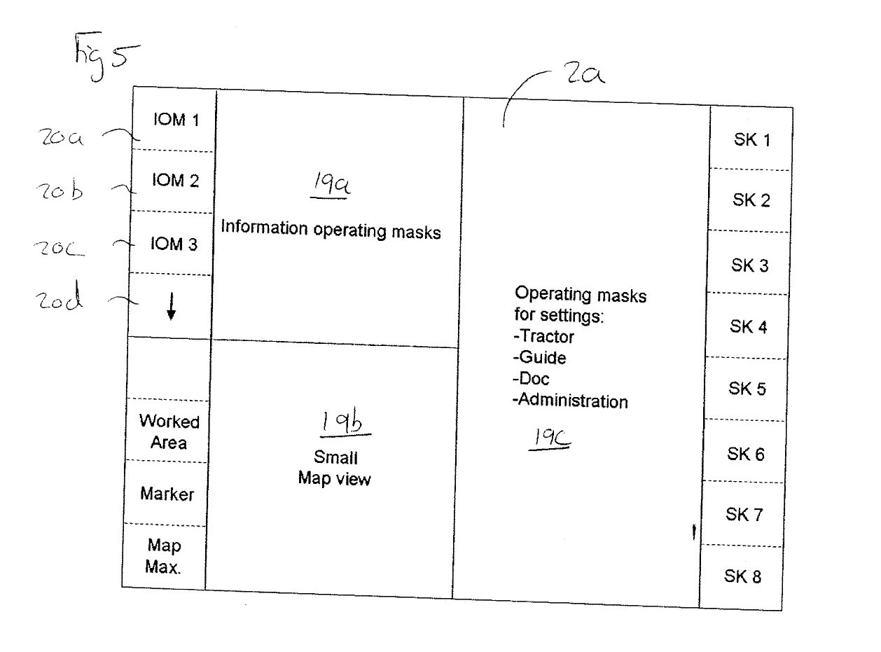

FIGS. 2a and 2b show end and forward facing views respectively of the terminal in accordance with a further embodiment of the invention,

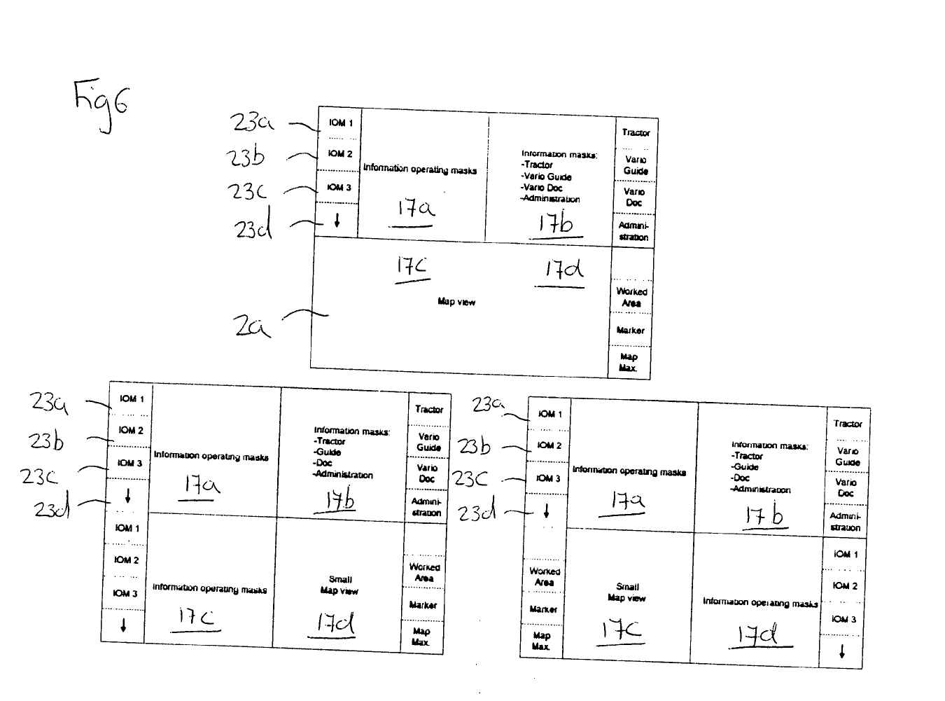

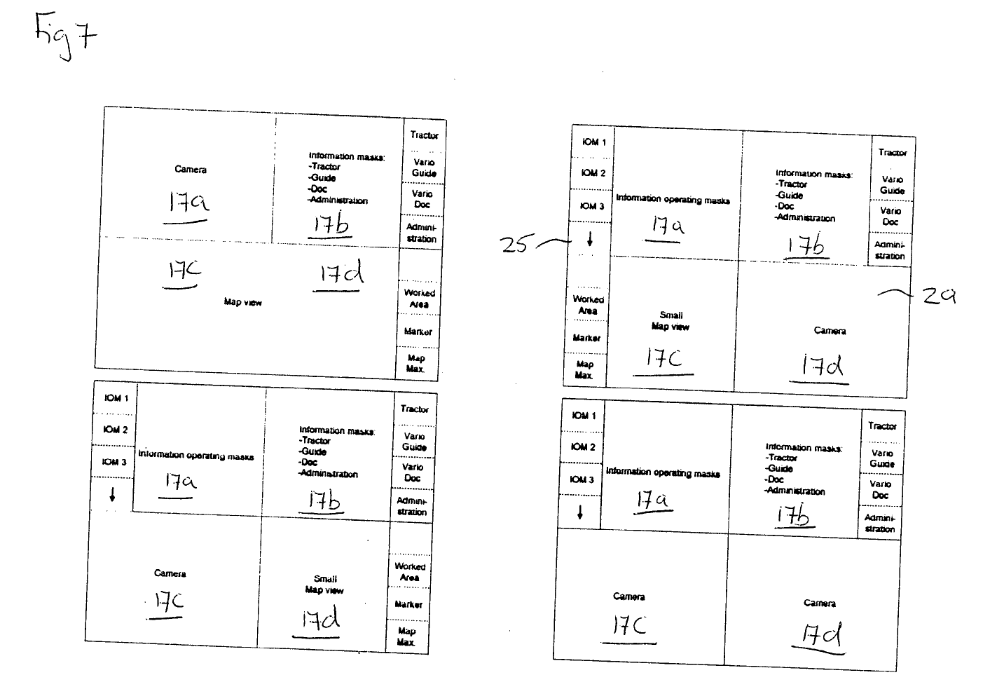

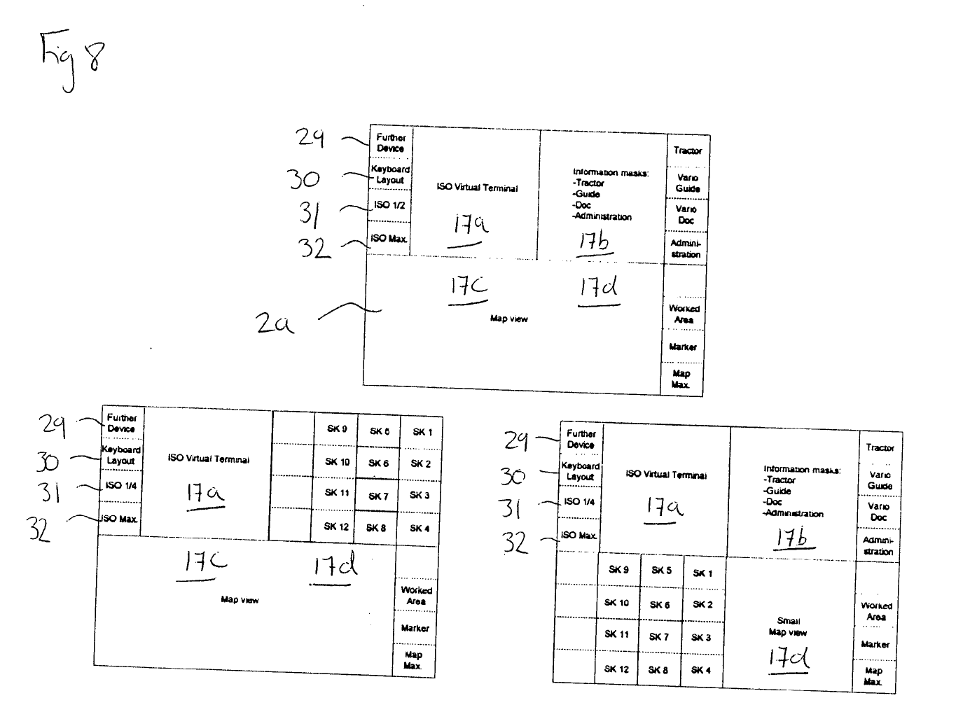

FIG. 3 is an example of a terminal screen layout of the Application groups,

FIG. 3a is the graphical representation of FIG. 3 as viewed on the screen of the terminal,

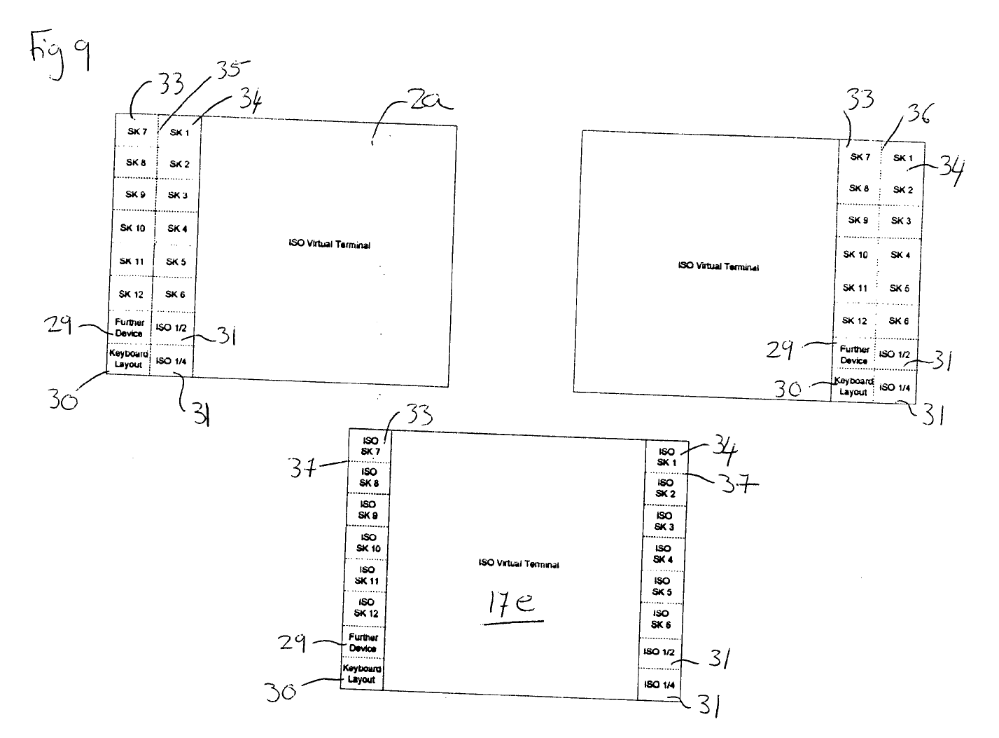

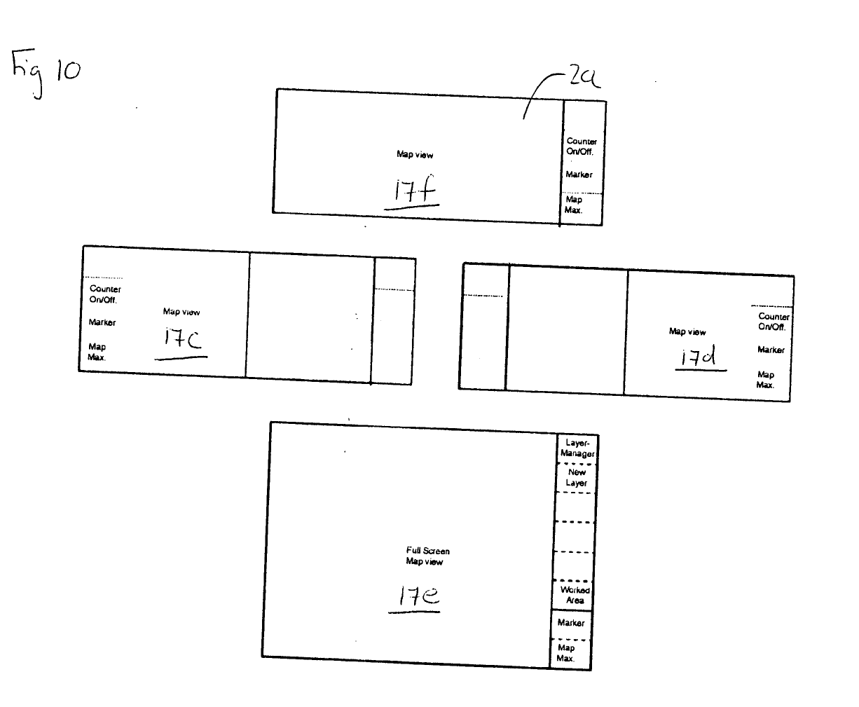

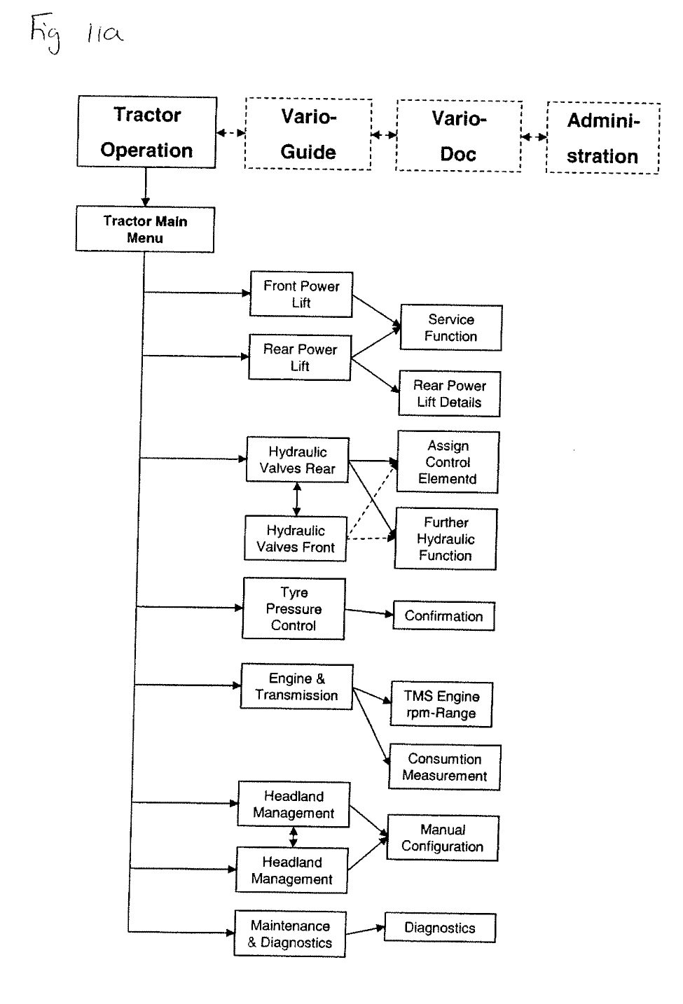

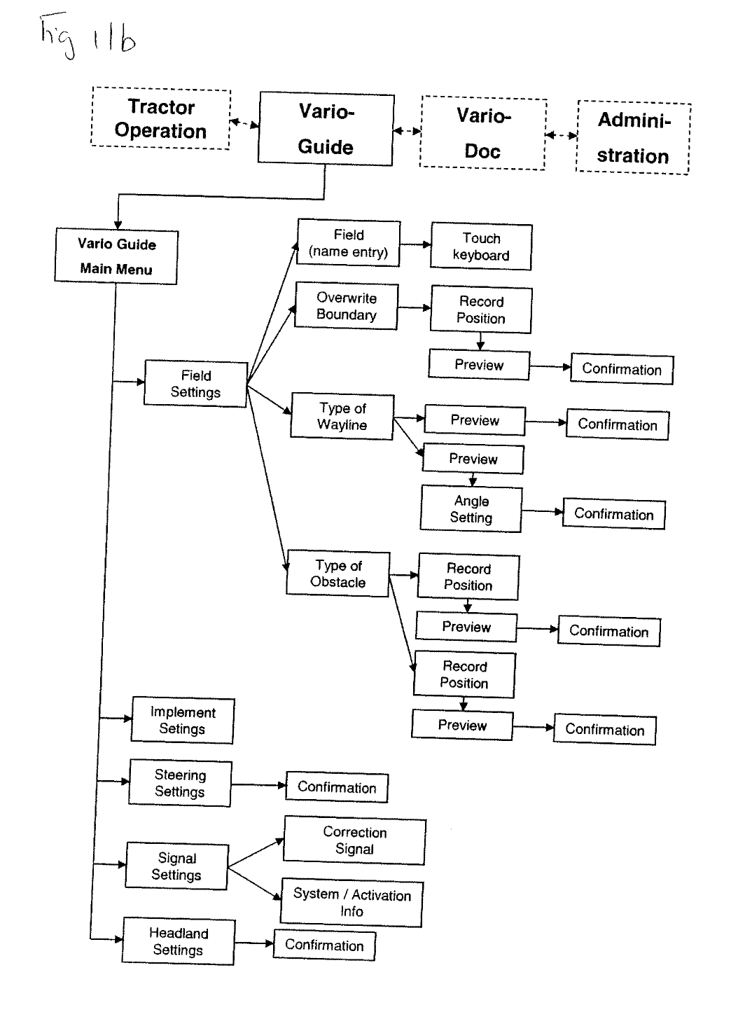

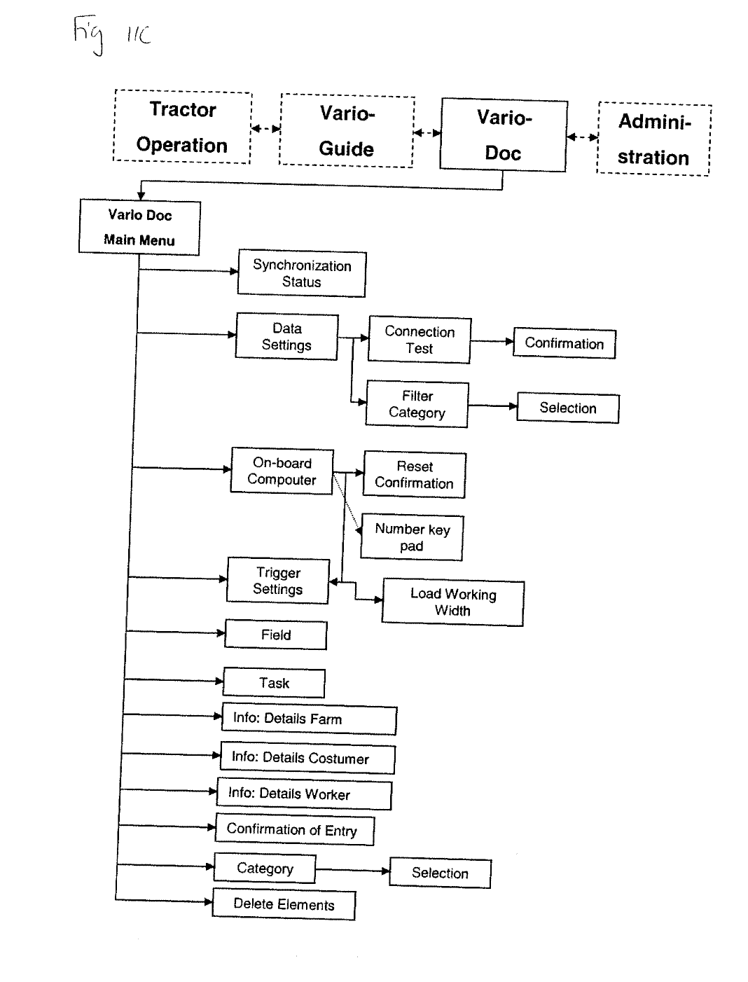

FIGS. 4 and 5 are examples of standard screen layouts for the large terminal,

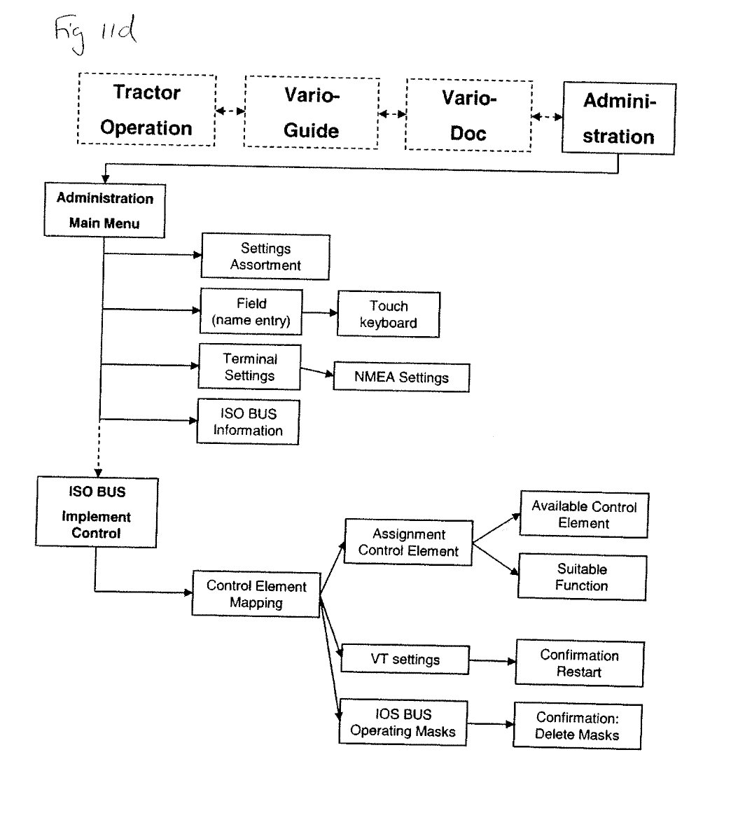

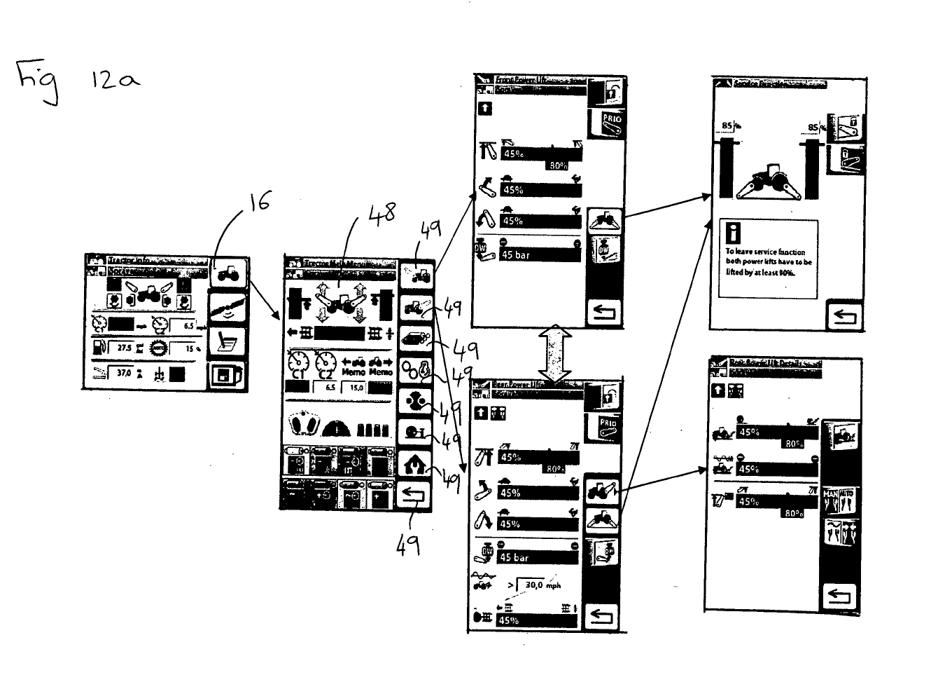

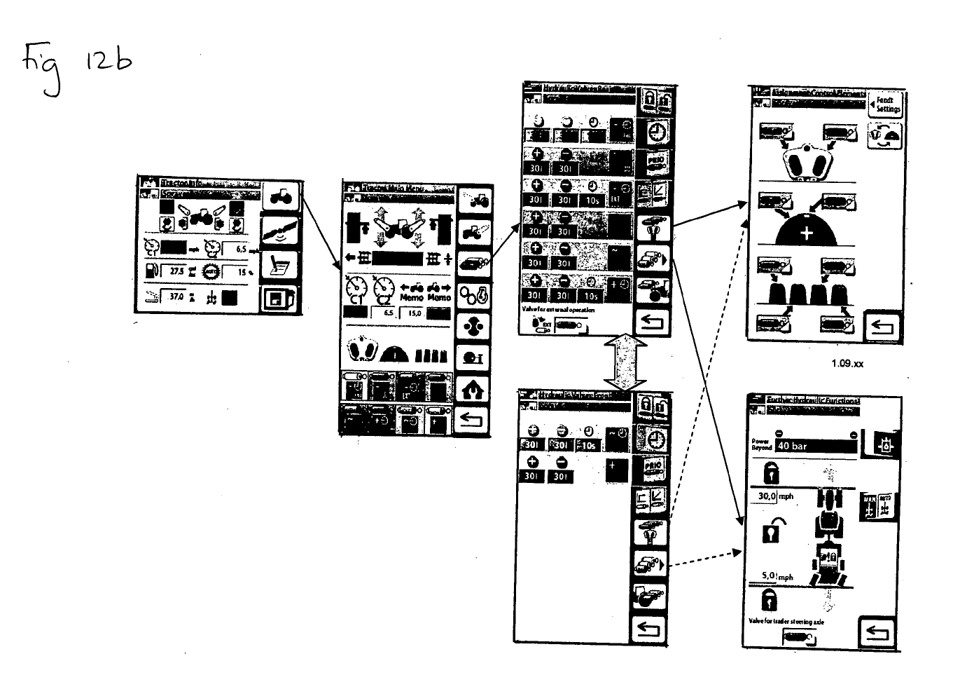

FIG. 6 are examples of screen layouts for information operating masks,

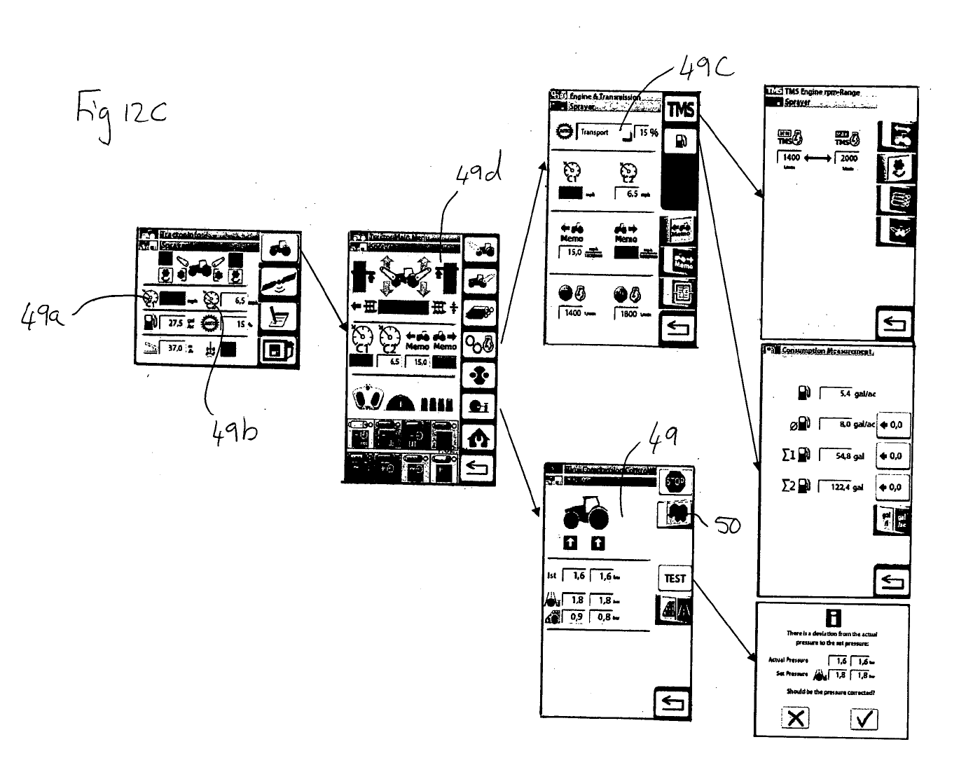

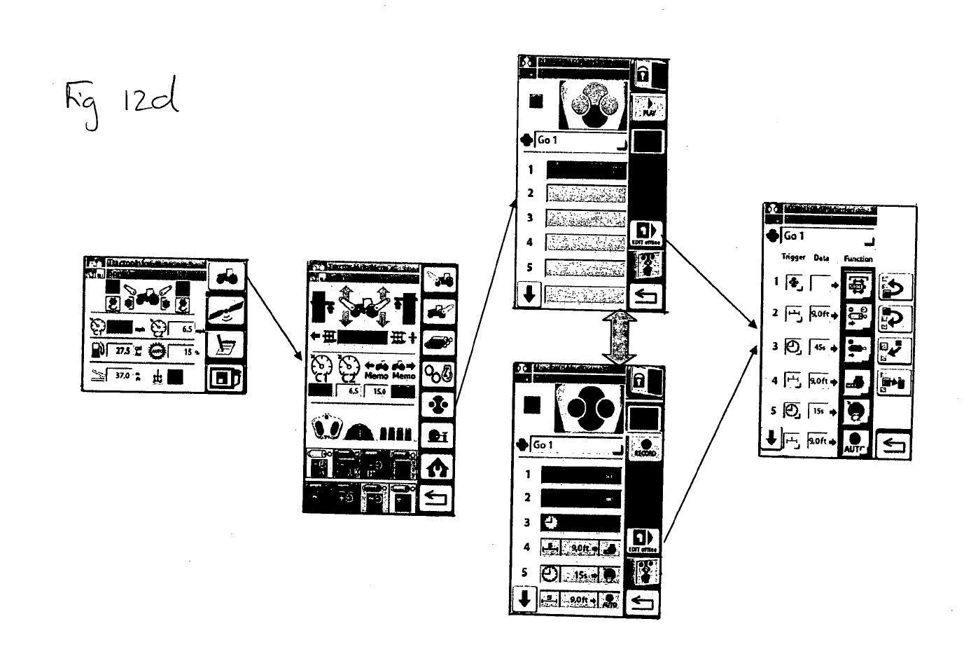

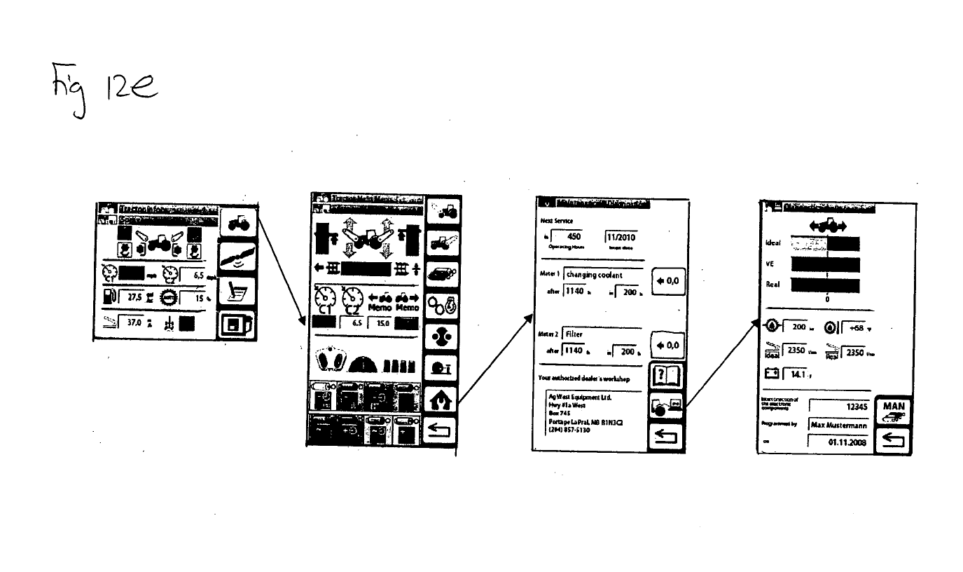

FIG. 7 are examples of screen layouts for camera applications,

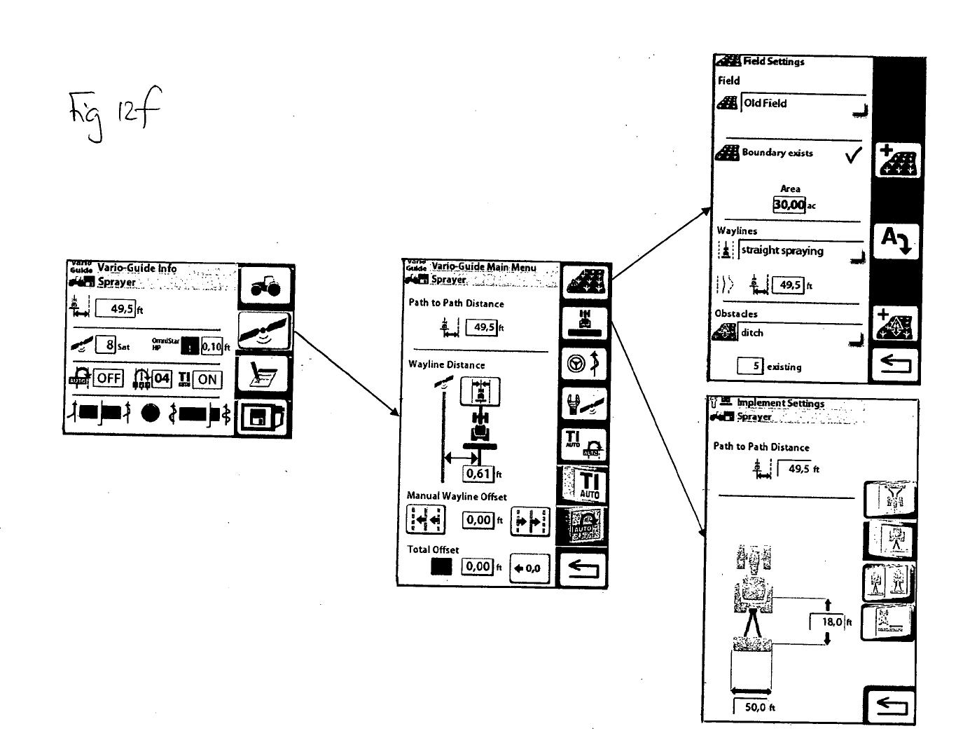

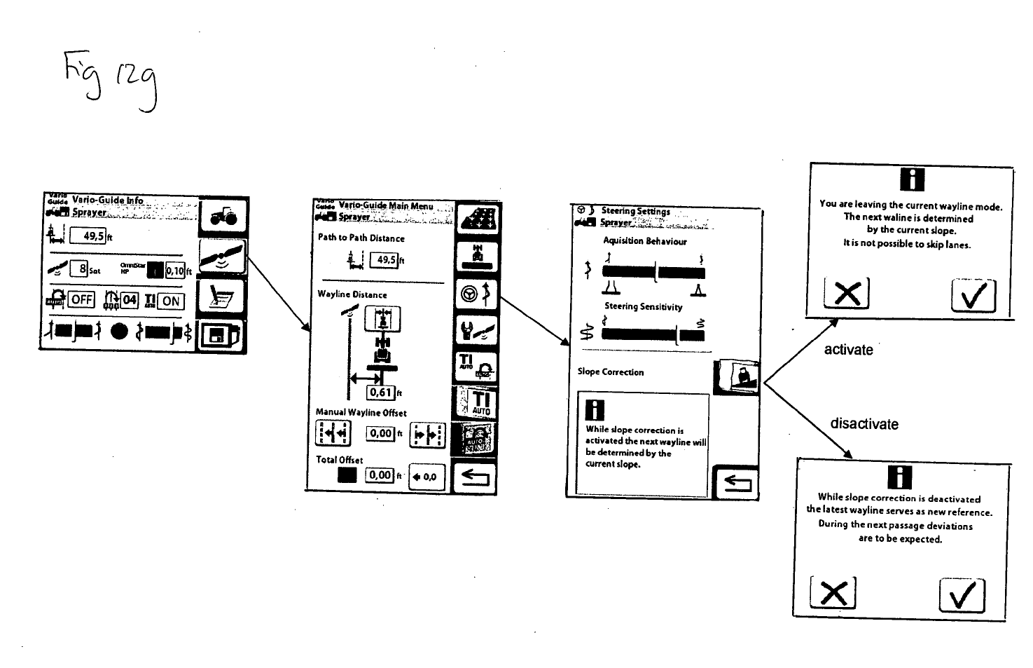

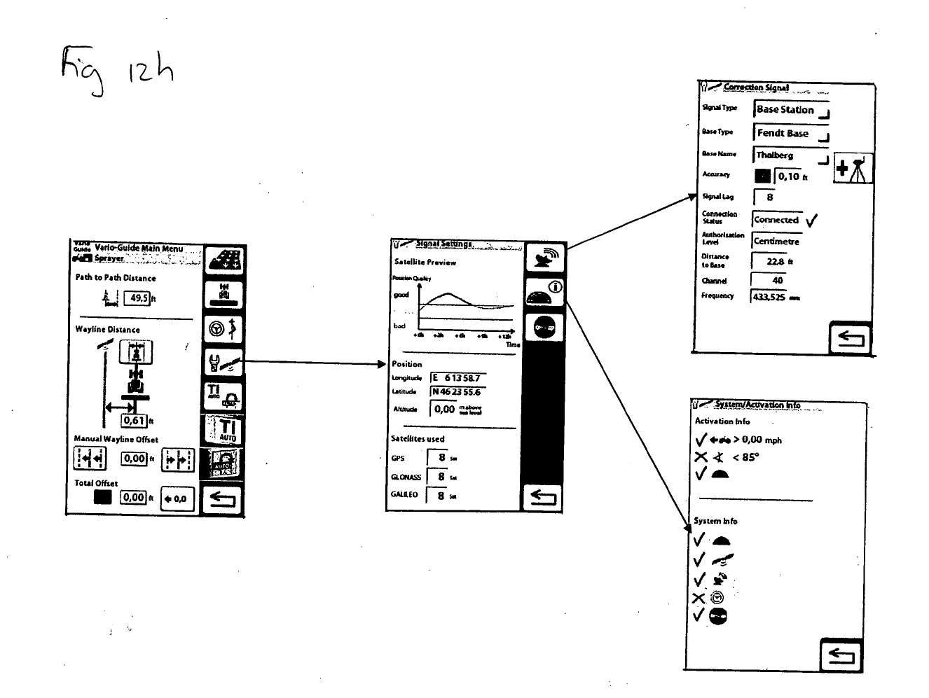

FIG. 8 are examples of screen layouts for ISOBUS implement masks,

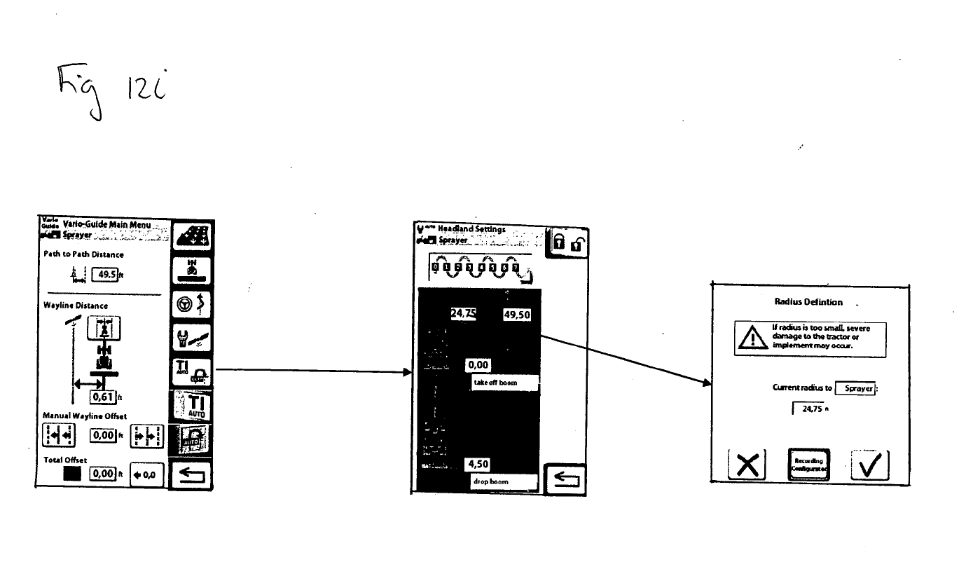

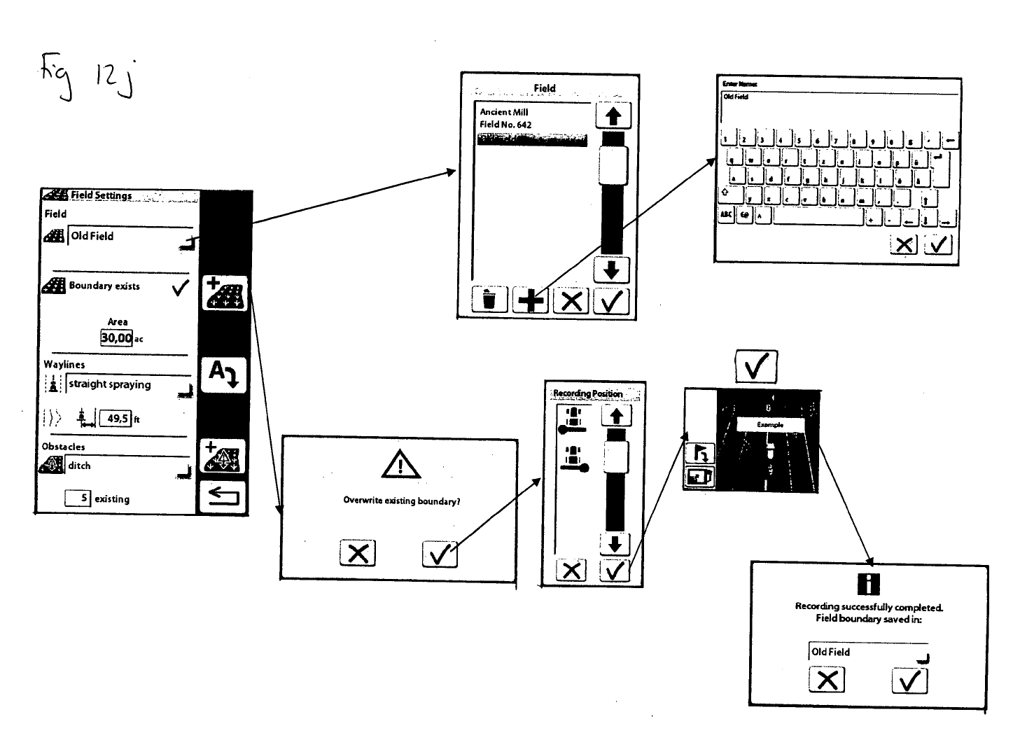

FIG. 9 is an example of screen layouts of the ISOBUS soft keys in full screen mode,

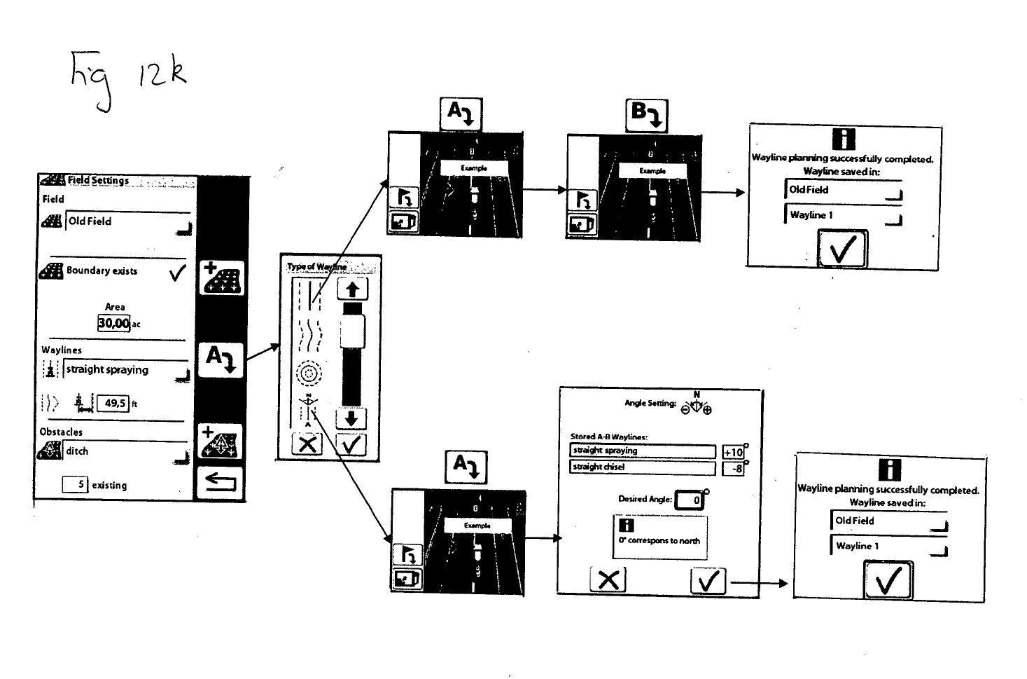

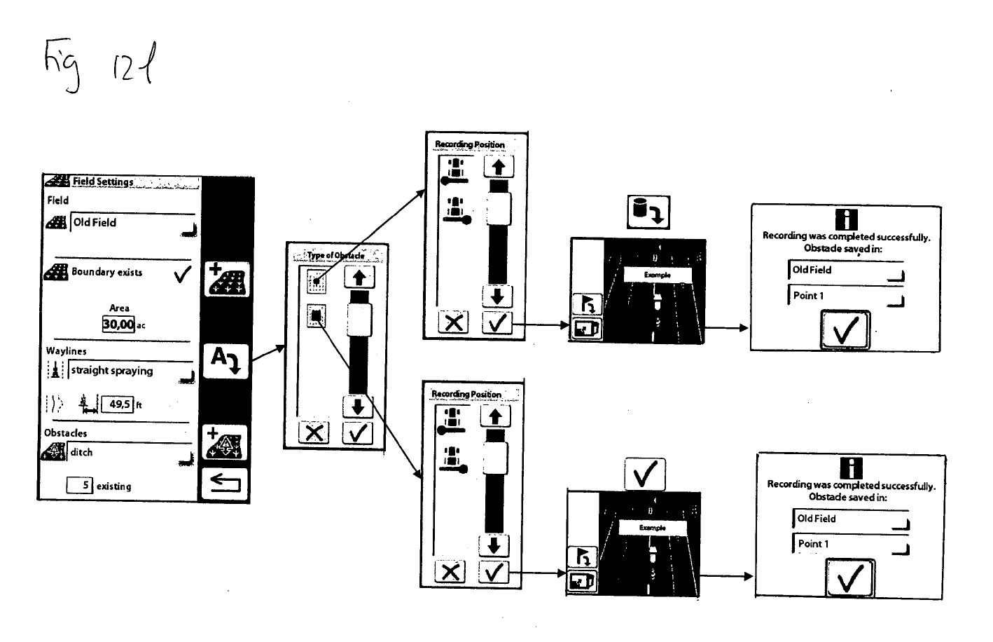

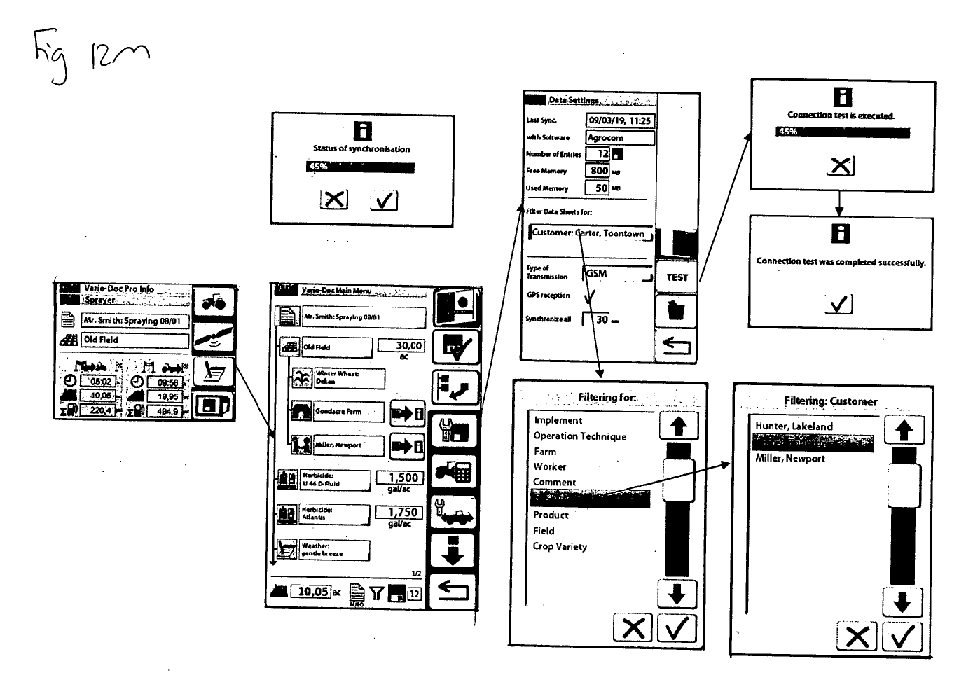

FIG. 10 is an example of a screen layout with Map Views,

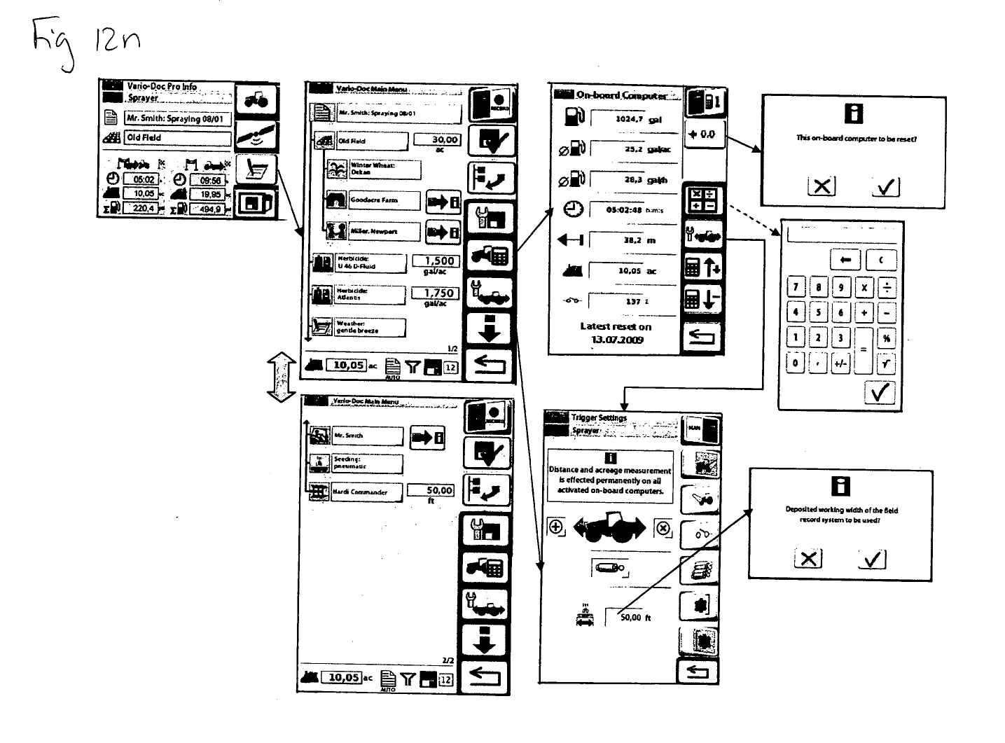

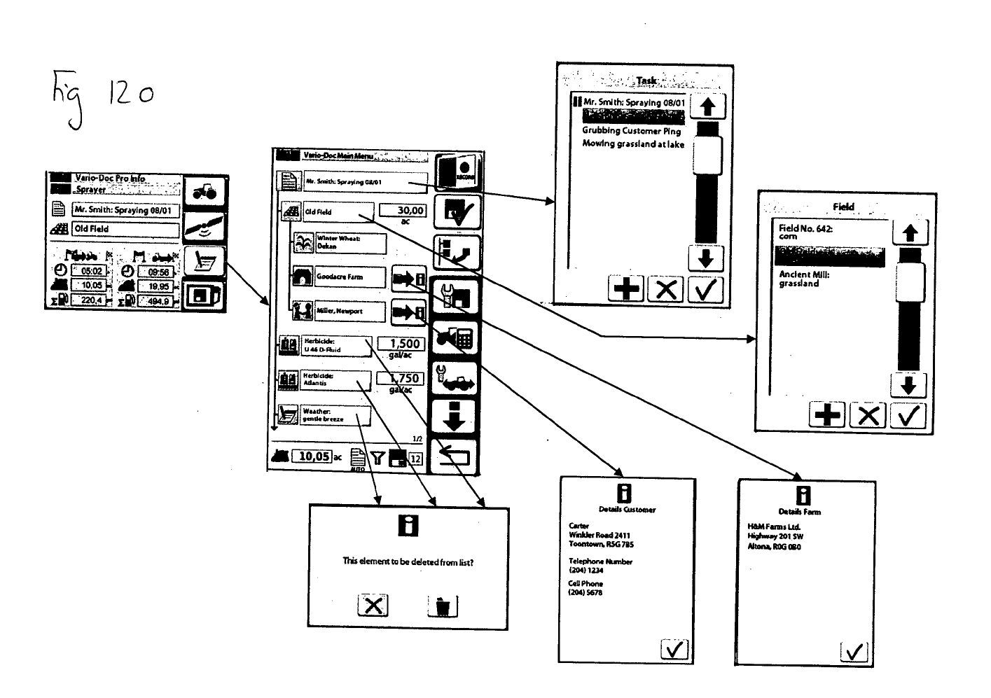

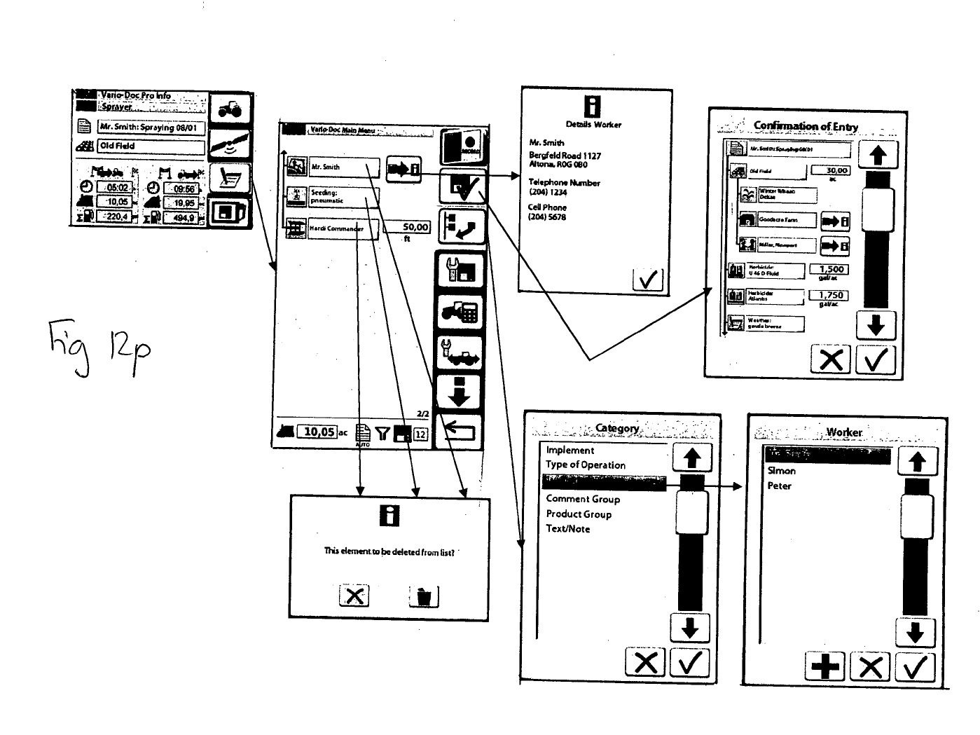

FIGS. 11a to 11d are flow diagram of the sub menus stemming from the main menus in the Tractor Applications Group,

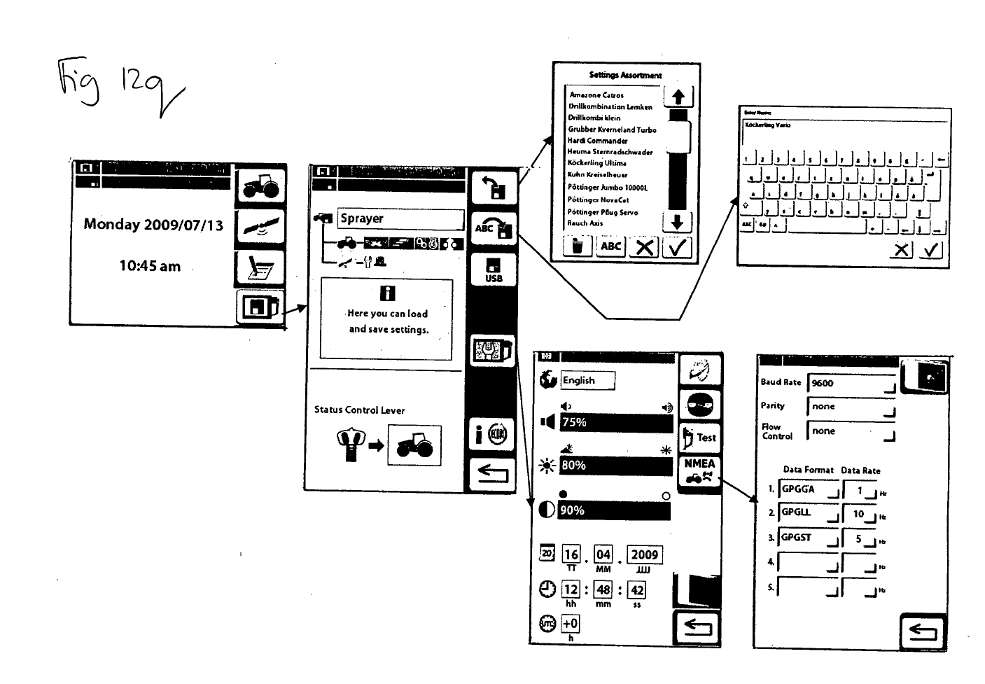

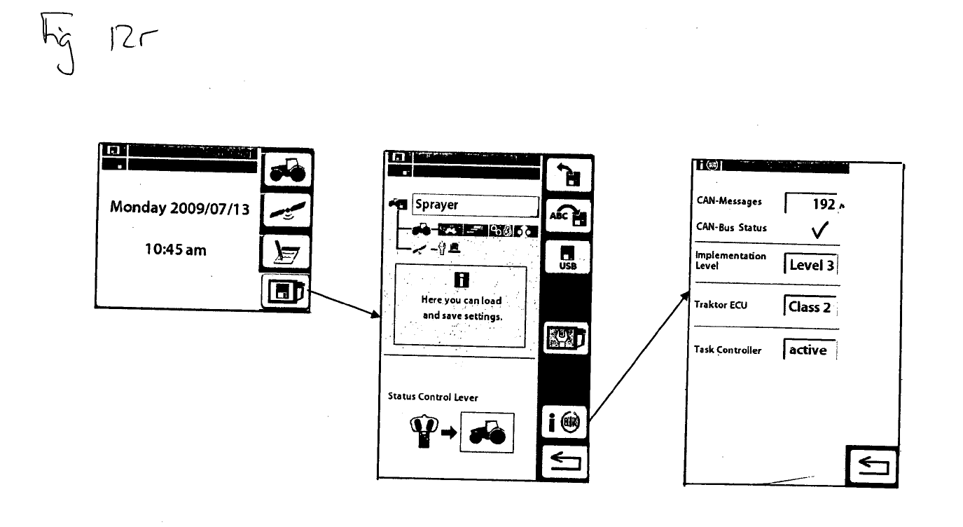

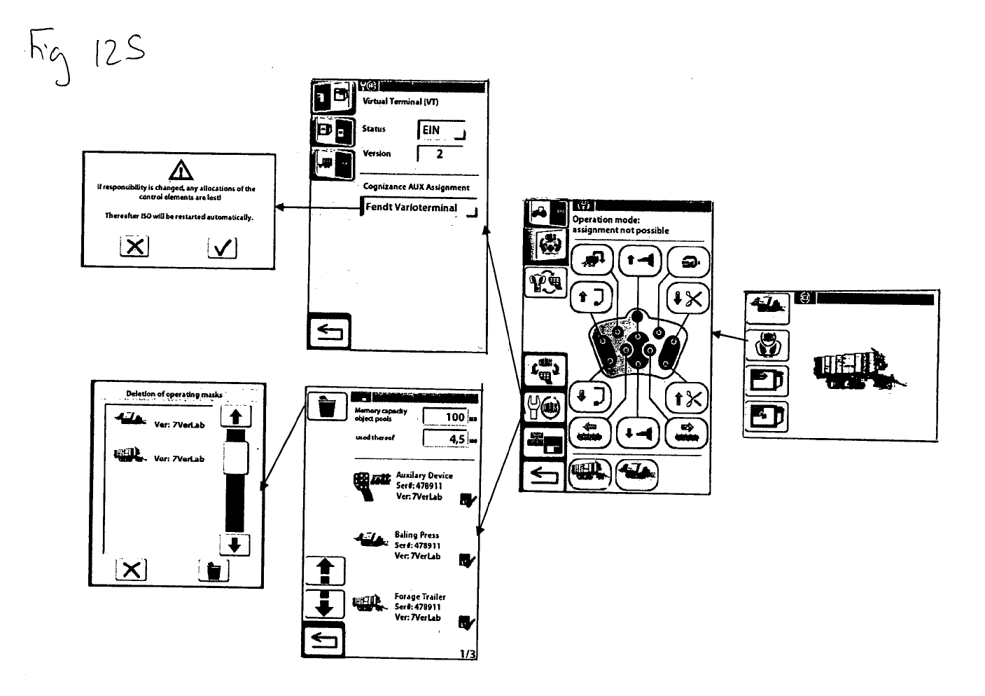

FIGS. 12a to 12 are flow diagrams with screen shots of the various sub menus stemming from the main menus in the Tractor Applications Group, and

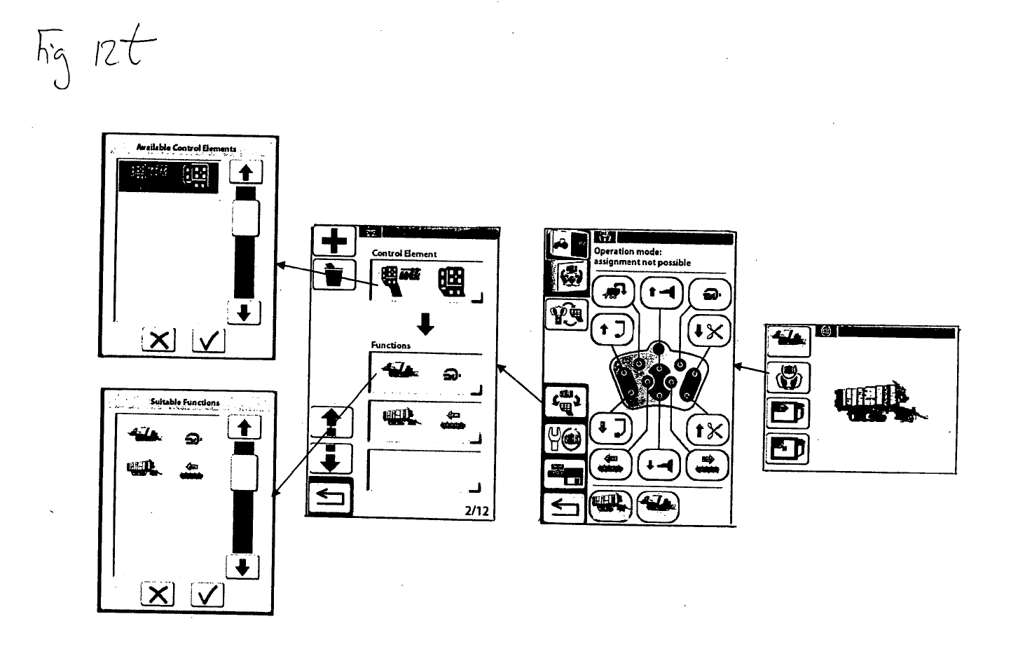

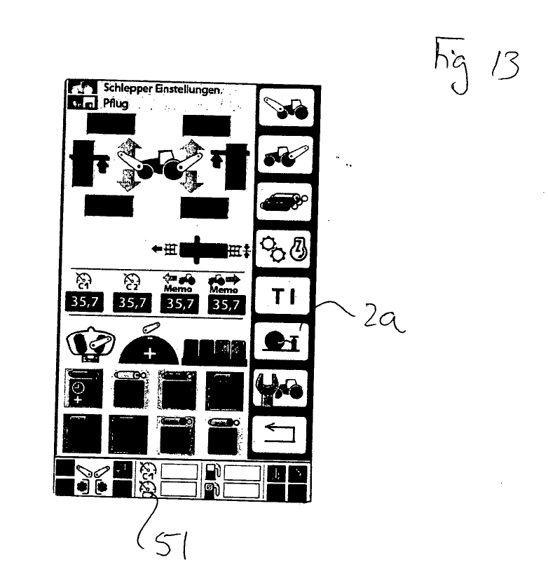

FIG. 13 is a screen shot on a terminal in accordance with the further embodiment of the invention.

FIGS. 1a and 1b show an end and a forward facing view respectively of a rectangular display terminal 1. Such a terminal, hereinafter referred to as the large terminal has a rectangular screen unit 2 having a touch sensitive display screen 2a with a display area typically 15.9×21 cm. FIGS. 2a and 2b show an end and a forward facing view respectively of a smaller display terminal 1, hereinafter referred to as the small terminal in which the touch sensitive screen 2a typically has dimensions 15.2×9.1 cm. In FIGS. 1a, 1b, 2a and 2b the same reference numerals are used for the same features.

The terminal 1 is suitable for use in an agricultural machine and in the example described herein, the display terminal 1 is for use in an agricultural tractor. The terminal 1 comprises the screen unit 2, a control unit 3 and computer housing (not shown). The control unit 3 comprises a handle portion 4 and a rectangular pad of push buttons 5. In an alternative construction the control unit 3 may be detachable from the screen unit 2 and connected thereto by wires, or wirelessly. This detachable control unit can be attached to another support surface for ease of operation by the operator. For example, the control unit could be attached to a tractor cab seat. The handle portion 4 which comprises a straight, elongated central element and a shorter connecting element for connection to the screen unit 2 provides the operator with a grip to steady and support the hand of the operator whilst allowing the thumb to operate the pad of buttons 5 positioned above the handle portion 4. The terminal 1 may be mounted on an adjustable support stand (not shown) so that the screen unit 2 and control unit 3 can be tilted about substantially horizontal and vertical axes. In total there are nine buttons positioned on the pad. To the side of the pad of buttons 5 is a rotary knob 6, also operable by the operator's thumb. The buttons and/or touch screen are used to navigate around the terminal screen 2a which comprises a number of application groups and menu levels associated with the control and operation of the tractor. The function of each of the buttons 5a to 5f is as follows:

OK button 5a—Confirms the selected function/the performed action

Esc button 5b—T the ESC button jumps up one menu level each time it is pressed. Pressing it longer than 2 seconds takes the operator back to the top menu of the current application (explained later). This is comparable to pressing ESC several times.

? 5c—Help button. Displays help info nation on operating the terminal/tractor functions. It opens an Operating Manual with information of a selected function/parameter.

Cursor Arrow Controls 5d—four push buttons. The cursor controls can be used as an alternative to touch screen control for navigation around the screen 2a and for moving elements within information operating masks (explained later) and for moving layers in the map view (explained later). Pressing the cursor arrows moves the “focus” from one operating element on the screen to another.

Placement button 5e—In the case of the large terminal the placement button brings up a screen divided into four quadrants into which chosen application groups can be entered

Home 5f—Pressing the home button displays the tractor information mask (explained later) in an upper right quadrant in the case of the large screen terminal or in full screen view in the case of the small screen terminal. In all other quadrants the current applications are kept as chosen in the placement screen.

The rotary knob 6, or potentiometer is turned to set values or select items from lists to complete fields. Turning the rotary knob 6 faster changes values proportionally faster. Pressing the rotary knob 6 axially in direction P confirms a selection. It is redundant if the OK button in the centre of the cursor controls 5d is used.

Alternatively, or in addition to the pad of push buttons 5, the touch sensitive screen 2a may be used.

The touch sensitive screen 2a of the large terminal can be split into four quadrants which can display up to four different application groups which control and monitor various parameters associated with the tractor. The touch sensitive screen 2a of the small terminal cannot be divided and is always shown as full screen and can therefore only show one application group at a time. There are five application groups available:

1. Information Operating Masks (IOM)—pre-configured and user defined masks for specific uses of the tractor, such as transport, PTO shaft power uses, draft control of implement linkage and front loader work.

2. Tractor applications (Tractor Application)—comprises four main menu options: Tractor Operation, Vario Guide, Vario Doc and Administration (explained later).

3. Camera applications (Camera)—at least one camera may be mounted on the tractor and connected to the terminal so that different views around the tractor can be observed.

4. ISOBUS application (ISO)—the ISOBUS standard is used to control functions of an external implement associated with the tractor via the terminal. The identity operating parameters and current settings are stored in the implement and transferred to the terminal via the IS|OBUS connection. Via the terminal it is also possible to assign implement control functions to operating elements of the tractor.

5. Map View application (Map)—a map shows both information of the guidance and position location system fitted to the tractor and information of the documentation system. Information on the guidance system may include for example, directional lines, or the distance to the next turn. Documentation information, may include for example, the area that is being worked, or row markers. Furthermore, it is possible to zoom, to change the perspective and to manage the information in layers. In the Map View application, layers mean that different views of a map can be shown. For example, the first layer may contain a geographical map which is provided by navigation software. A second layer could be a map showing the same geographical area but with details such as the previous year's crop yield. A further layer could show an aerial photograph of the same area. The layers can be superimposed with the same scale and the same reference position (by using Cursor arrows 5d). This enables the operator to see the previous year's crop yield whilst driving along and spraying fertilizer with the help of a geographical map to navigate. The map may be displayed in the lower left or right quarter or in the lower half of the screen or full screen.

The small size terminal can only show Tractor Applications and ISO applications. Camera, Map and IOM applications cannot be shown.

FIG. 3 is the placement screen for a large terminal in which the display screen 2a is divided into four quadrants 17a, 17b, 17c and 17d. The permitted placement of each of the application groups: IOM, ISO, Camera, Map and Tractor Applications in each quadrant 17a, 17b, 17c and 17d is shown. Not all application groups can be placed in all quadrants.

Information operating masks, IOMs and camera applications can be selected for the upper left 17a, the lower left 17c and the lower right 17d quadrants. Tractor applications is permitted in the upper right quadrant 17b. ISO is permitted in the upper left quadrant 17a. Map application is permitted in the lower left 17c and/or in the lower right 17d quadrant. The sections marked SK 1 to SK 8 are the soft keys which give menu options for each of the application groups and can be displayed on both sides of the screen depending on the number of keys, settings and/or application requirements.

FIG. 3a shows the graphical representations of the touch sensitive screen 2a shown in FIG. 3 as viewed by the operator. The screen shown in FIG. 3a is of a large terminal which has been split into four quadrants 17a, 17b, 17c and 17d. The icons 12, 13, 14, 15, 16 represent ISO, IOM, Camera, Map and Tractor Application groups respectively. The icons represent areas of the touch sensitive screen 2a which can be activated to select the group desired. The cross and tick icons 16a and 16b can be selected to abort or confirm the settings selected.

FIGS. 4 and 5 show alternative standard screen layout configurations for the large terminal display.

In FIG. 4 the display screen 2a is divided into three sections, 18a, 18b and 18c. The screen is divided into two upper quadrants 18a and 18b and a lower half section 18c.

With this configuration the standard screen comprises:
An information operating mask (IOM) in the upper left quadrant 18a. The four adjacent soft keys 20a, 20b, 20c and 20d serve to switch between the available information operating masks. Soft key 20d has a downwards pointing arrow representing “Next”. Selecting “Next” takes the operator to further information operating masks (if available).
An information mask for Tractor Applications in the upper right quadrant 18b. The four adjacent soft keys 21a, 21b, 21c and 21d serve to switch between the four main menus: Tractor Operations, Vario Guide, Vario Doc and Administration. Pressing the soft key for the particular mask enlarges the mask to half-screen view as can be seen in FIG. 5, in section 19c of the screen 2a. In this example, the map applications is diminished into lower quadrant 19b. There can be short cuts in the information masks which lead to a respective setting function menu as a direct link over several levels in the menu. For example, in FIG. 12c the main Tractor Operations menu is chosen from the Tractor Application Group. The cruise control settings are shown together by icons 49 a and 49b. By pressing the icons 49a, 49b or touching the values themselves, the operator is directly guided by skipping one menu level to the cruise control setting menu 49c, that is one menu level (tractor main menu 49d) is skipped.
Map View in FIG. 4 is shown in the lower half of the screen 18c. The four adjacent soft keys on the right 22a, 22b, 22c and 22d serve to control the map functions. In this example, soft key 22a has not been assigned a function.

The following options are available for changing the standard view:
Pressing the soft keys 20a to 20d again for the shown information mask, or touching a short cut in the information mask area expands it towards the bottom right half of screen and displays the corresponding (main) mask for setting functions
Pressing the Placement key calls up the “Placement” screen, in which each quadrant can be assigned to a different application group.

In FIG. 5, the display screen 2a is divided into three sections, 19a, 19b and 19c. Two quadrants 19a and 19b lie on the left hand side of the screen and half a screen 19c covers the right hand side. The tractor application view is shown as expanded. A standard screen layout includes all possible screen configurations, in which the Map application uses either the entire lower half of the screen (if an IOM is displayed in the upper right quarter) or the lower left quarter of the screen (if application is expanded on the right half of the screen), and either a Tractor application is shown as an Information Mask in the upper right quadrant or an expanded tractor application is shown in the right half of the screen 19c. The lower left quadrant 19b can be occupied by an operating mask or a camera application.

Tractor applications 16 has four main menu titles:
Tractor Operation
Vario Guide
Vario Doc
Administration

Each one has an information mask (always displayed in an upper right quadrant which can be selected with adjacent soft keys) and one or more operable masks for setting the required functions. The operable masks take up both right quadrants, or the right half of the screen (300×600 pixels) and have eight adjacent soft keys SK1-SK8. The setting masks can be called up from the information masks by pressing the corresponding soft key for the application again or by touching a short cut in the info mask. The setting masks are exited by going back stepwise with the ESC button or by pressing the Home button.

FIG. 6 shows screen layout examples for placement of information operating masks, IOMs.

The information operating masks can be placed in three quadrants 17a, 17c and 17d (not in upper right quadrant 17b). Zero to three information operating masks can be displayed. Information operating masks are possible in all combinations with the permissible placement of other application groups.

Each IOM has adjacent soft keys to permit switching to all other information operating masks. If more than four information operating masks have been defined, a “Next” icon appears on the fourth soft key.

FIG. 7 shows possible screen layout examples for camera applications, Camera. At least one camera may be mounted on the tractor and views from the camera may be viewed on the large terminal by the operator.

Camera applications can be placed in all three quadrants 17a, 17c and 17d except the upper right quadrant 17b . Zero to two camera pictures can be shown at the same time. Camera pictures are possible in all combinations with the permissible placement for other application groups.

If more than four function soft keys are available, a “Next” icon 25 appears on the fourth soft key.
The four soft keys that belong to the camera application are displayed for 10 seconds after the camera has been selected, and are then hidden. This permits the picture to be displayed in an approximate 4:3 format. Touching the camera picture displays the four corresponding soft keys for 10 seconds again.
The camera application can be enlarged to full screen view.

FIG. 8 shows screen layout examples for ISOBUS implement masks and assignment of the ISOBUS soft key bar.

Operating masks for the ISOBUS (ISO) implement applications are shown in the upper left quadrant 17a. Zero to one ISOBUS implement mask can be shown, even if more than one ISOBUS implement is connected. The ISOBUS implement mask is possible in all combinations with the permissible placement for other application groups.

The ISO mask is displayed on a quarter of the screen in a 30033 300 pixel area with a 10-pixel border (tapering off to black towards the middle), so that an ISO mask effectively has 280×280 pixels. This also applies to camera functions and information operating masks, to separate them visually from each other on the screen.
The displayed soft keys of an ISOBUS implement also have a graphic border so they can be adapted to the design concept of the tractor. The actual ISOBUS buttons (supplied by the ISOBUS job computer) only take up a part of the entire button (for example, a button: 100×75, ISOBUS bitmap: 80×60). The appearance of the border is defined by the terminal software.

Soft key 29 (labelled “Further device”) is only displayed if more than one ISOBUS implement is connected to switch between the implements' masks. Soft key 30 (labelled “Keyboard Layout”) leads to the control element mapping mask Y1 for assigning the control elements. Soft key 31 (labelled “ISO 1/2” or “ISO 1/4”) changes the ISO mask display format. Soft key 31 is labelled “ISO 1/2” if the ISO masks takes one quarter of the screen as shown in FIG. 8 top graphic. Soft key 31 is labeled “ISO 1/4” if the ISO mask occupies two quadrants as shown in both lower graphics. Soft key 32 (labelled “ISO Max.”) enlarges the implements' mask to full screen.

The control element mapping mask 51 from the Administration menu is used to set the keys on the physical control element as shown in FIG. 12s. The control element mapping mask has two modes which can be selected by toggle switch 52. In the assignment mode it is possible either to touch on the area of the displayed control element or to operate a button on the physical control element and assign a function of connected implements. In the operation mode the current assignment is shown during operation.

FIG. 9 shows examples of screen layouts of the ISOBUS soft keys in full screen mode.

ISOBUS implement masks can be enlarged to a full screen view 17e. This is done by pressing soft key 32 in the ISOBUS quadrant (FIG. 8). There are always two soft key bars 33, 34 columns in full screen view. The soft keys SK1 to SK12 are available for the functions of the ISOBUS application, the bottom soft keys 29, 30 and 31 are for controlling the screen as explained above (for returning to view in the upper left quadrant with or without the implement's control soft keys, for switching to another implement, if any, and for assigning the control elements). The soft key bars can be displayed in three different arrangements in the ISOBUS full screen mode:
Two-column soft key bar left 35
Two-column soft key bar right 36
One one-column soft key bar on each side of the screen 37

Other than when the “minimise” soft key 31 is pressed (in full screen mode), pressing 31 “ISO 1/2” or “ISO 1/4” reduces the size of the mask to half a screen or a quadrant respectively. The full screen mode is also exited when:
Home (press button) is pressed
The “placement function” (press button) is pressed; restores the last state used before full screen mode and executes the placement function

The known procedure to exchange display information between a virtual terminal on a tractor and a control unit on an attached implement according to ISO 11783 standard will now be described. Whenever a virtual terminal on the tractor is switched on, the control unit on the implement sends a signal to the terminal requesting the desired operating mask size in order to provide the operating mask with the requested size, for example, 200×200 pixels. This operating mask with its specific size is then displayed on the virtual terminal of the tractor. If the display size of the operating mask on the tractor terminal is then changed by the operator, the virtual terminal needs to communicate again with the control unit on the implement to report the new operating mask size. The implement control unit will then send the operating mask in the newly requested size, for example, 280×280 pixels. The communication process between the terminal and the control unit to reset the graphical resolution causes considerable delays, around 6 to 8 seconds. Due to this delay, the dynamic zooming will result in undesirable screen flicker on the tractor terminal.

The effect of the poor communication of the pixel size between the tractor terminal and the implement control unit is caused by the fact that ISO 11783 tries to avoid the display resizing (especially downsizing) in the terminal which results in a loss of information. For example, if the virtual terminal displays a warning sign (a red triangle) with additional symbols inside, these symbols can be lost, or be unrecognizable when the pixel size is reduced by scaling.

This is not the case for the terminal of the present invention. The resizing of an ISO 11783 quarter size data mask for the terminal described herein is implemented by a terminal internal scaling mechanism. The implement is requested to send its operating mask in a basic size, for example 200×200 pixels or 280×280 pixels. Preferably, the implement control unit is requested to send the maximum resolution of its operating mask. After that, the implement is not informed about a change of the number of pixels used on the terminal screen. This allows a very fast change of the screen size on the terminal, for example changing between quarter and full screen, or somewhere in between. Even a magnifying mechanism of partial areas of the operating mask is achievable. One advantage is to enhance the visibility for the operator by dynamically changing the used number of pixels. This approach is a virtual, stepless zoom (in and out) mechanism, independent of the used number of pixels on the screen. The terminal which uses very small sized pixels can achieve a large and clear view of the displayed operating mask by reporting a basic size of fewer pixels than used on the real screen. The virtual, stepless zoom mechanism also allows real-time drag effects to be actioned, for example, moving a finger over the touch screen of the terminal to enlarge or downsize screen areas.

FIG. 10 shows placement layouts of various Map Views.

Based on the previous descriptions, a number of different formats are possible for the interactive map view in the lower screen area (the soft keys are not included in the specified dimensions):
Entire lower screen area 17f with soft key bar on right (700×300 pixels; standard view)
Square in the lower left quadrant 17c or lower right quadrant 17d with soft key bar left or right (300×300 pixels)

Furthermore, the map can also be shown in full screen mode 17e.

FIGS. 11a to 11d show flow diagrams of the sub menus and applications which stem from the four main menus in the Tractor Applications group entitled: Tractor Operations, Vario Doc, Vario Guide and Administration.

For example, in FIG. 11a in the main Tractor Operation menu, parameters such as front and rear lifts, tyre pressure and headland management can be monitored and/or controlled through respective sub menus. In the Vario Guide menu, FIG. 11b, parameters relating to automatic steering (directional line, working width) can be monitored and/or controlled. In the Vario Doc menu, FIG. 11c parameters relating to documentation, such as customer name, driver name etc, or on-board computers can be monitored and/or controlled. In the Administration menu, FIG. 11d, parameters relating to terminal settings, centralized management of settings can be monitored and/or controlled.

Flow charts with screen shots for each of the sub menus viewed by the operator are shown for each of the four main menus: Tractor Operations, Vario Doc, Vario Guide and Administration in FIGS. 12a to 12t.

FIGS. 12 a to 12e show flow diagrams using screen shots. Icon 16 represents the Tractor Operations menu. Selecting this menu takes the operator to the Tractor Operations mask indicated as 48 on FIG. 12a. Selecting one of the soft key buttons 49 takes the operator to one of the sub menus indicated in FIG. 11a.

FIGS. 12f to 12l show flow diagrams using screen shots relating to sub menus in Vario Doc.

FIGS. 12m to 12p show flow diagrams using screen shots relating to sub menus in Vario Guide.

FIGS. 12q to 12t show flow diagrams using screen shots relating to sub menus in Administration.

The terminal 1 can be used to save a set of settings (in particular implement specific settings) as a profile. The settings may be saved on the terminal or downloaded onto an electronic memory device such as a USB stick. The settings can therefore be stored and transferred to another machine or tractor equipped with the terminal. As a reminder, before the terminal shuts down, the terminal asks the operator whether it wants to save its settings.

The terminal allows operators to transfer data and information from an agricultural machine via a remote server maintained for example by the tractor manufacturer to a personal computer from which the data can be downloaded over the internet. An ISO XML format is used which enables operators to transfer data from the terminal to a personal computer regardless of the software used. The XML standard offer exchange of data over a wide range of farm based applications irrespective of the software needed.

FIG. 12c shows a screen shot 49 of a Tyre Compression Control application (which is the subject of a co-pending patent application filed by the applicant) which is accessed through the Tractor Operations menu. A virtual switch toggle 50 is shown so that the operator can select tyre pressures suitable for use on a road or in field. The virtual toggle switch has the appearance of a physical switch and is actioned by selecting it with the button pad 5 and pressing the OK button, or by touching it on the screen 2a.

FIG. 13 is a screen shot of the small size terminal. For this terminal, no quadrants are viewed and the screen is always full screen. Only Tractor applications and ISOBUS applications can be accessed on this screen. The elements of the tractor information mask 51 are shown on the lower edge of the screen 2.

1. A display terminal for a tractor or other agricultural machine, the terminal having a touch sensitive screen where the pressing of pre-determined areas of the screen designated as control areas initiate pre-determined actions in the operation of the terminal or machines, the terminal also having a control unit and a matrix of push buttons external to the screen the pressing of which duplicates the pressing of the touch sensitive screen areas.

2. A display terminal as claimed in claim 1 wherein partial areas of the touch sensitive screen can be re-sized by touching the screen

3. A display terminal as claimed in claim 1 wherein re-sizing of a data mask on the screen is implemented by an internal terminal scaling mechanism.

4. A display terminal as claimed in claim 1 wherein the control unit also comprises a rotary knob for entry of data values associated with designated fields selected by using the touch sensitive screen or the push buttons and/or selection of screen displayed parameters.

5. A display terminal as claimed in claim 1 wherein, the control unit comprises a steadying portion which provides a grip for steadying the operator's hand whilst allowing operation of the push buttons by the thumb of the hand.

6. A display terminal as claimed in claim 1 in which the control unit is detachable from the screen.

7. A display terminal as claimed in claim 1 wherein at least one of the touch sensitive screen areas comprises a virtual toggle switch which indicates the state of operation of the function concerned.

8. A display terminal as claimed in claim 1 wherein the screen is split into a number of predetermined areas for the display/control of different machine operating or control parameters.

9. A display terminal as claimed in claim 8 wherein the screen is split into four quadrants to display/control different machine operating or control parameters.

10. The display terminal as claimed in claim 1 wherein the screen has an area which includes a list of pre determined functions of the machine which can be assigned to separate areas of the screen for the display of predetermined parameters relating to the selected function.

11. A display terminal according to claim 10 in which the touch sensitive areas or buttons are used to select from the predetermined functions in the separate areas of the screen.

12. A display terminal according to claim 1 wherein data concerning an operating or control parameter is transferable between the display terminal and a personal computer via a remote server.

13.-22. (canceled)

23. A display terminal according to claim 12 wherein an ISO XML format is used to transfer the data.

24. A display terminal according to claim 11 wherein the data is downloadable from the server over the internet.

25. A display terminal according to claim 1 wherein data concerning an operating or control parameter is stored on the terminal.

26. A display terminal according to claim 25 wherein the data can be saved onto a portable memory device.

27. A display terminal for a tractor or other agricultural machine, the terminal having a screen and a control unit, wherein the control unit comprises a steadying portion and at least one push button, the steadying portion providing a grip for steadying the operator's hand whilst allowing operation of the at least one button by the thumb of the hand.

28. A display terminal according to claim 27 wherein the control unit is detachable from the screen.

29. A display terminal according to claim 28 wherein the control unit is connected to the screen by a cable or wirelessly.

30. A display terminal according to claim 27 wherein the control unit includes a pad of push buttons.

31. A display terminal according to claim 27 wherein the control unit includes a rotary dial operable by the thumb for the input of data or the selection of a screen displayed parameter.

32. A display terminal according to claim 1 offered in two versions, a first higher specification version and a second lower specification version, the higher specification version having a screen which can be divided into four quadrants and the second lower specification version having a smaller undivided screen.
